(19) United States
(12) Patent Application Publication
(10) Pub. No.: US 2012/0113120 A1
(43) Pub. Date: May 10, 2012

(54) METHOD AND APPARATUS FOR GENERATING A VISUAL REPRESENTATION OF INFORMATION

(75) Inventor: Jose Enrique GALLAR, Helsinki (FI)

(73) Assignee: NOKIA CORPORATION, Espoo (FI)

(21) Appl. No.: 12/940,824

(22) Filed: Nov. 5, 2010

(51) Int. Cl. G06T 11/20

(52) U.S. Cl. 345/440

(57) ABSTRACT

An apparatus, comprising computer program code configured to cause the apparatus to perform at least generating a first visual representation comprising a visual representation of a tag arrangement based at least in part on a first time period, receiving indication of an input associated with a selectable time period associated with the tag arrangement, determining a second time period based at least in part on the received indication of the input, and generating a second visual representation of a tag arrangement based at least in part on the second time period is disclosed.

### RELATED APPLICATIONS

This application relates to U.S. application Ser. No. 12/940,817 entitled, “Method and Apparatus for Generating a Visual Representation of Information”, filed Nov. 5, 2010.

### TECHNICAL FIELD

The present application relates generally to visual representation of information.

### BACKGROUND

Electronic devices are experiencing widespread use in today's society. Many electronic devices are capable of storing vast amounts of information, such as audio, video, messages, contact information, etc. Over time an apparatus may accumulate more information than a user may be able to comprehend. In addition, an apparatus may access information stored on multiple devices, resulting in even more information for the user to comprehend.

### SUMMARY

Various aspects of examples of the invention are set out in the claims.

An apparatus, comprising computer program code configured to cause the apparatus to perform at least generating a first visual representation comprising a visual representation of a tag arrangement based at least in part on a first time period, receiving indication of an input associated with a selectable time period associated with the tag arrangement, determining a second time period based at least in part on the received indication of the input, and generating a second visual representation of a tag arrangement based at least in part on the second time period is disclosed.

A method comprising generating a first visual representation comprising a visual representation of a tag arrangement based at least in part on a first time period, receiving indication of an input associated with a selectable time period associated with the tag arrangement, determining a second time period based at least in part on the received indication of the input, and generating a second visual representation of a tag arrangement based at least in part on the second time period is disclosed.

A computer-readable medium encoded with instructions that, when executed by a computer, perform generating a first visual representation comprising a visual representation of a tag arrangement based at least in part on a first time period, receiving indication of an input associated with a selectable time period associated with the tag arrangement, determining a second time period based at least in part on the received indication of the input, and generating a second visual representation of a tag arrangement based at least in part on the second time period is disclosed.

### BRIEF DESCRIPTION OF THE DRAWINGS

For a more complete understanding of embodiments of the invention, reference is now made to the following descriptions taken in connection with the accompanying drawings in which:

FIGS. 1A-1E are diagrams illustrating visual representations of message chains according to at least one example embodiment;

FIGS. 2A-2H are diagrams illustrating visual representations of message information according to at least one example embodiment;

FIG. 3 is a flow diagram showing a set of operations for representing a message chain according to at least one example embodiment;

FIG. 4 is a flow diagram showing a set of operations for representing a message chain according to at least one example embodiment;

FIGS. 5A-5E are diagrams illustrating visual representations of tag arrangements according to at least one example embodiment;

FIGS. 6A-6B are diagrams illustrating visual representations of message information associated with a tag according to at least one example embodiment;

FIG. 7 is a flow diagram showing a set of operations for representing a message chain according to at least one example embodiment;

FIG. 8 is a flow diagram showing a set of operations for representing a message chain according to at least one example embodiment;

FIGS. 9A-9E are diagrams illustrating input associated with a touch display, for example from display 28 of FIG. 8, according to at least one example embodiment; and

FIG. 10 is a block diagram showing an apparatus according to at least one example embodiment.

### DETAILED DESCRIPTION OF THE DRAWINGS

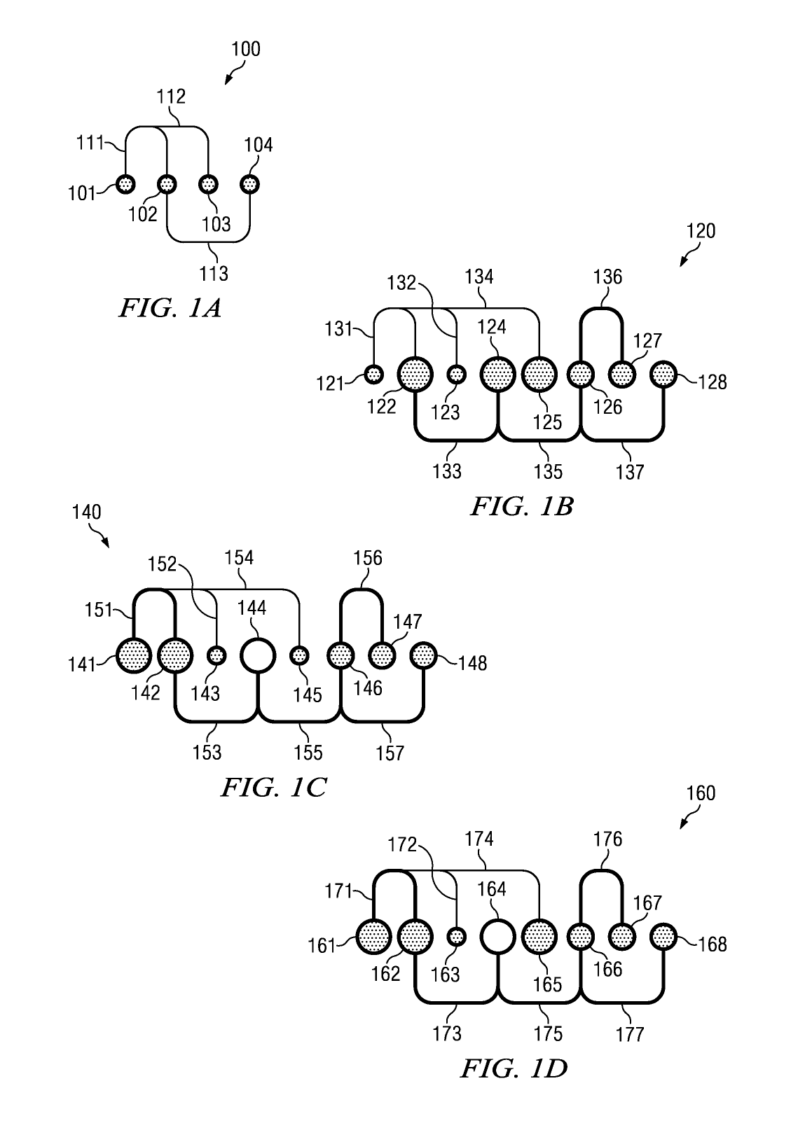

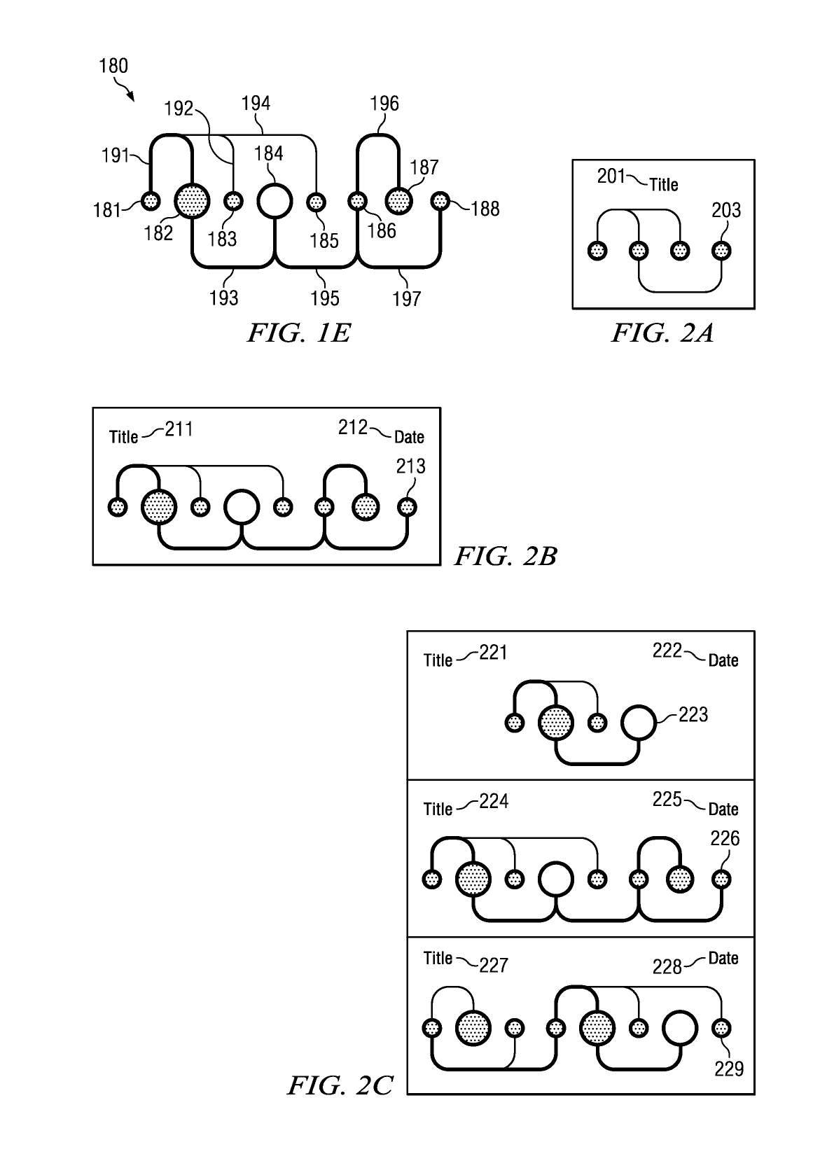

An embodiment of the invention and its potential advantages are understood by referring to FIGS. 1A through 10 of the drawings.

As a user accumulates information on an electronic device, it may become increasingly difficult for the user to find desired information among the vast amounts of stored information within the device. Such difficulty may result in the user spending an increasing amount of time trying to find desired information. In addition, such difficulty may result in an apparatus spending an increasing amount of time navigating through the stored information while the user tries to find the desired information.

It may be desirable to provide information to the user in a way that allows the user to better comprehend the information stored on a device. The user may benefit from an arrangement of the information that assists the user in understanding a context associated with the information. For example, a user may be assisted by understanding how one set of information relates to another set of information. In addition, the user may be assisted by understanding what subject matter may be included in various sets of information. Under such circumstances the user may benefit from a concise representation of information that communicates such aspects of stored information.

FIGS. 1A-1E are diagrams illustrating visual representations of message chains according to at least one example embodiment. The examples of FIGS. 1A-1E are merely examples of visual representations of message chains, and do not limit the scope of the claims. For example, representation of nodes may vary, representation of node connectors may vary, representation of focus message may vary, and/or the like. In another example, number of nodes may vary, number of connectors may vary, number of focus messages may vary, and/or the like.

In an example embodiment, a message relates to an instant message, a chat message, a text message, an email message, a video message, a multimedia message, a voice message, a voice call, and/or the like. The message may be synchronous or asynchronous.

In an example embodiment, a message chain relates to messages that have associations with each other, such as a composition relationship, an assigned association, and/or the like. An assigned association may relate to an association between messages based on a determination that the messages are related. For example, a user providing an indication that messages are related may result in an assigned association. A composition relationship may relate to creation of a message. A composition relationship may be a response composition relationship, a forward composition relationship, and/or the like. For example, if a user receives a first message and forwards the first message via a second message, there may be a composition relationship, for example a forward composition relationship, between the first message and the second message. In another example, if a user receives a first message and replies to the first message via a second message, there may be a composition relationship, for example a reply composition relationship, between the first message and the second message.

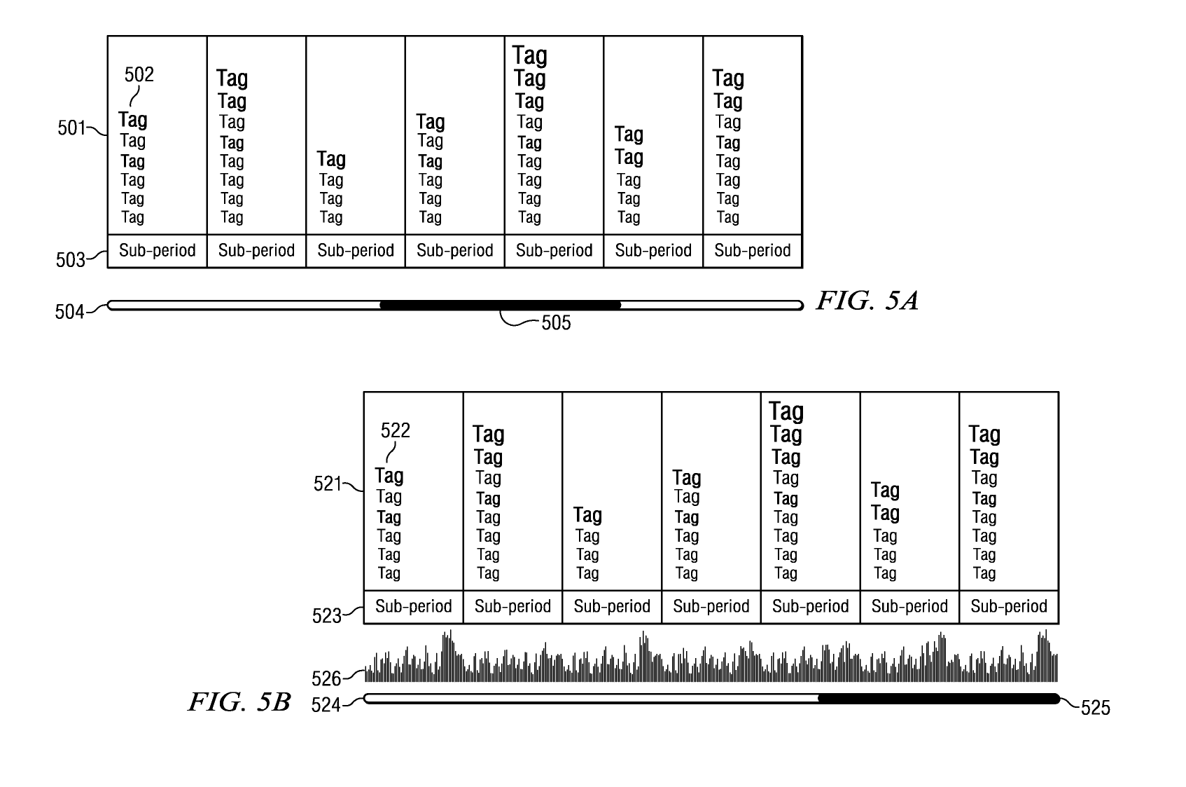

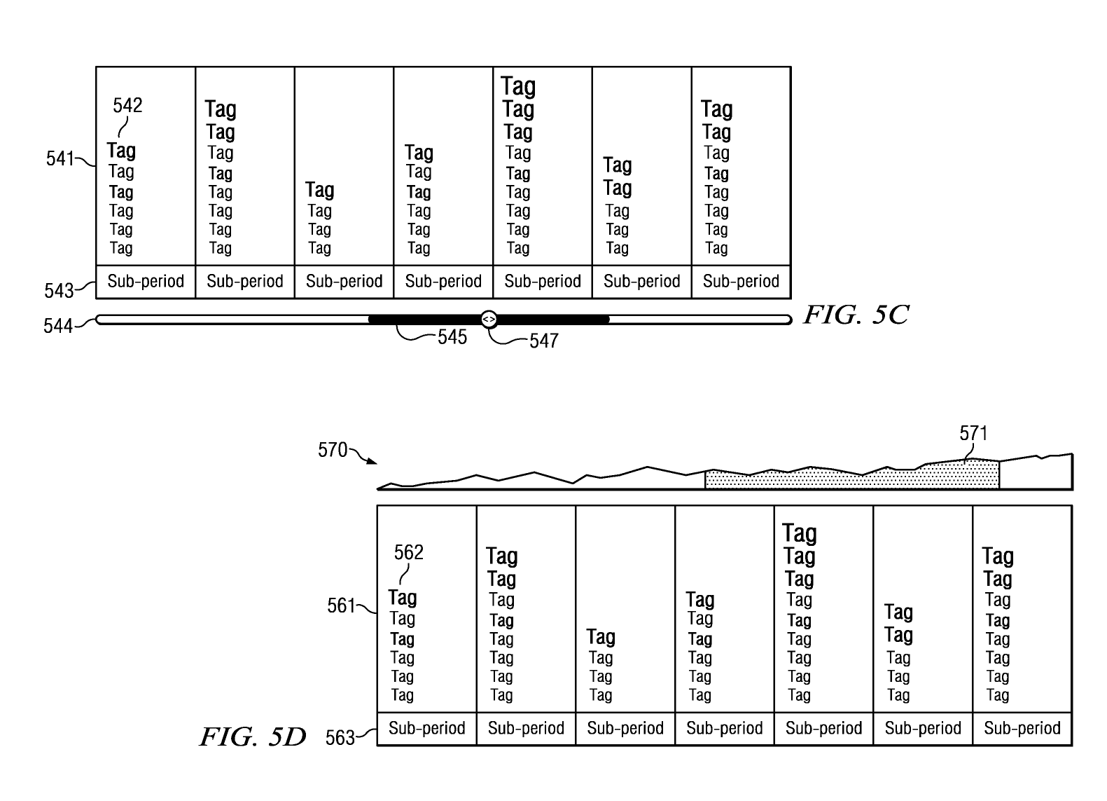

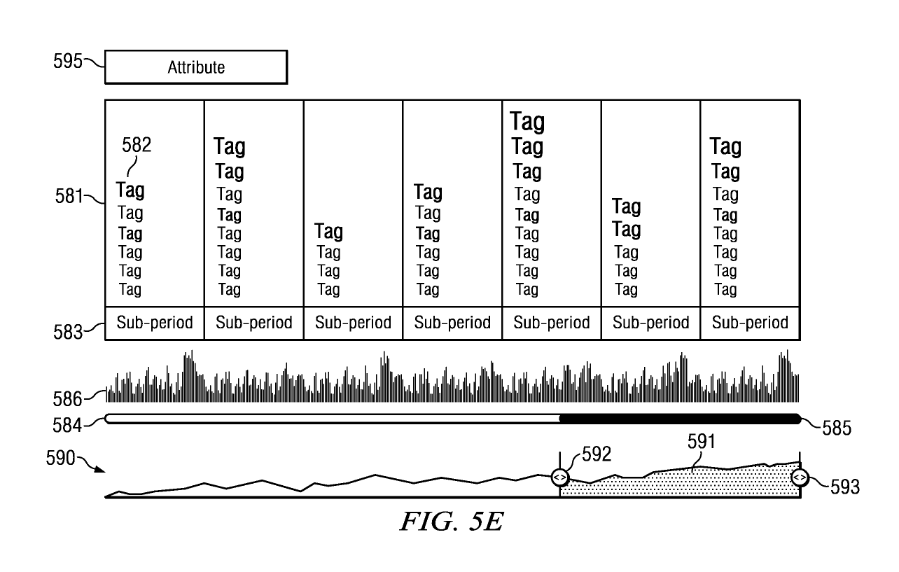

A visual representation of a message chain may comprise nodes that represent messages that have an association with each other. The nodes may indicate one or more attributes associated with the messages represented by the nodes. An attribute of a message may comprise a message time stamp, a message participant, a tag associated with the message, at least part of message metadata, status information, and/or the like. Such categorization of an attribute relates to an attribute type. For example, there may be a time stamp attribute type, a message participant attribute type, a tag attribute type, and/or the like. A message time stamp may be a time associated with the message being sent, a time associated with the message being received, and/or the like. A message participant may be a person to whom the message is sent, a person who sent the message, a person who composed the message, and/or the like. A tag may be similar as described with reference to FIGS. 5A-5E. The attribute may be a non-tag attribute. A non-tag attribute may be an attribute that is an attribute other than a tag, such as a message participant. The indication of an attribute associated with a message represented by a node may be position of the node in relation to different node, color of the node, size of the node, shading of the node, outline of the node, and/or the like. For example, position of the node may relate to a message time stamp. In such an example, a node that represents a message may be represented above a node that represents a message associated with a later time stamp. In an example embodiment, a node may indicate that a message is unassociated with an attribute. For example, a node that represents a message that is unassociated with an attribute may be represented differently than a node that represents a message that is associated with the attribute. In such an example, a node that represents a message that is unassociated with an attribute may be indicated by a visual representation having a lighter color than a visual representation of a node. The indication of an attribute unassociated with a message represented by a node may be position of the node in relation to different node, color of the node, size of the node, shading of the node, outline of the node, and/or the like. In an example embodiment, an attribute indicator is represented in association with a node. For example, the apparatus may represent an indicator for presence of an attachment adjacent to a node representing a message that comprises the attachment.

A visual representation of a message chain may comprise at least one node connector. A node connector may be a visual representation of an association between messages represented by the nodes. A node connector may have a plurality of node connectors that connect to a plurality of nodes.

In an example embodiment, a message chain may indicate at least one focus message. A focus message may be a message having representational significance. For example, the representation significance may relate to a message that has been selected by a user, a message having representational dominance over another message, and/or the like. Representational dominance of a message may comprise having more information represented than another message, such as an attribute, part of a message body, and/or the like. Indication of the focus message may relate to representation of the node, representation of information associated with the focus message, and/or the like.

In an example embodiment, an apparatus indicates nodes that represent messages within the message chain flow of a focus message. A message within the message chain flow of the focus message may be a message that has a parent relationship or child relationship with the focus message. A parent relationship may be a relationship which extends between a first message and a second message from which the first message was composed. For example, the first message may have been composed through replying to the second message. The message chain flow may comprise messages having a recursive parent relationship with the focus message. For example, a message chain flow may comprise the parent message of the focus message, the parent message of the parent message of the focus message, and/or the like. A child relationship may be a relationship which extends between a first message and a second message composed from the first message. The message chain flow may comprise messages having a recursive child relationship with the focus message. For example a message chain flow may comprise a child message of a focus message, a child message of the child message of the focus message, and/or the like.

In an example embodiment, a user correlates importance with messages that are associated with an attribute as well as messages within a message chain flow. In such circumstances a user may desire for nodes that represent messages that are associated with an attribute and nodes that represent messages within a message chain flow be commonly indicated.

In an example embodiment, a visual representation may commonly indicate nodes that represent messages that are associated with an attribute and nodes that represent messages within the message chain flow. For example, an attribute association may be indicated by a color of a node, and a message being within the message chain flow may be indicated representing the node of the message within the message chain flow by the same color.

In an example embodiment, a user correlates low importance with messages unassociated with an attribute as well as messages outside a message chain flow. In such circumstances a user may desire for nodes that represent messages unassociated with an attribute and nodes that represent messages outside a message chain flow be commonly indicated.

In an example embodiment, a visual representation may commonly indicate nodes that represent messages that are unassociated with an attribute and nodes that represent messages outside the message chain flow. For example, an attribute unassociation may be indicated by a color of a node, and a message being outside the message chain flow may be indicated representing the node of the message within the message chain flow by the same color.

In an example embodiment, an apparatus may indicate node connectors between nodes that represent messages within a message chain flow. For example, node connectors between nodes that represent messages within the message chain flow may be indicated by color, thickness, shading, and/or the like.

In an example embodiment, an apparatus may indicate node connectors between nodes that represent messages wherein at least one message is outside a message chain flow. For example, node connectors between nodes that represent messages wherein at least one message is outside the message chain flow may be indicated by color, thickness, shading, and/or the like.

In an example embodiment, an apparatus may indicate node connectors between nodes that represent messages that are associated with an attribute. For example, node connectors between nodes that represent messages that are associated with an attribute may be indicated by color, thickness, shading, and/or the like.

In an example embodiment, an apparatus may indicate node connectors between nodes that represent messages wherein at least one message is unassociated with an attribute. For example, node connectors between nodes that represent messages wherein at least one message is unassociated with an attribute may be indicated by color, thickness, shading, and/or the like.

FIG. 1A is a diagram illustrating a visual representation 100 of a message chain according to at least one example embodiment. Visual representation 100 comprises nodes 101, 102, 103, and 104. The horizontal arrangement of nodes may relate to a time stamp. For example, node 102 may have a later time stamp than node 101. Node connector 111 connects node 101 and node 102. Node connector 112 connects node 101 and node 103. Node connector 113 connects node 102 and node 104. Node 101 may be a parent of node 102, and a parent of node 103. Node 102 and node 103 may be children of node 101. Node 102 may be a parent of node 104. Node 104 may be a child of node 102.

FIG. 1B is a diagram illustrating a visual representation 120 of a message chain according to at least one example embodiment. Visual representation 120 comprises nodes 121, 122, 123, 124, 125, 126, 127, and 128. The horizontal arrangement of nodes may relate to a time stamp. For example, node 122 may have a later time stamp than node 121. Node connector 131 connects node 121 and node 122. Node connector 132 connects node 121 and node 123. Node connector 133 connects node 122 and node 124. Node connector 134 connects node 121 and node 126. Node connector 135 connects node 124 and node 126. Node connector 136 connects node 126 and node 127. Node connector 137 connects node 126 and node 128. Node 121 may be a parent of node 122, a parent of node 123, and a parent of node 126. Node 122, node 123, and node 126 may be children of node 121. Node 122 may be a parent of node 124. Node 124 may be a child of node 122. Node 124 may be a parent of node 126. Node 126 may be a child of node 124. Node 126 may be a parent of node 127 and node 128. Node 127 and node 128 may be a children of node 126.

In the example of visual representation 120, nodes 122, 124, 125, 126, 127, and 128 are indicated by a large circle and nodes 121 and 123 are indicated by small circles. Indication of a large circle may be indication that the message represented by the node is associated with an attribute. Indication of a small circle may be indication that the message represented by the node is unassociated with the attribute. Node connectors 133, 135, 136, and 137 are represented as thick connectors, and node connectors 131, 132, and 134 are represented as thin connectors. Indication of a thick connector may indicate a node connector between two nodes that represent the attribute. Indication of a thin connector may indicate connection between two nodes, wherein at least on node is unassociated with the attribute.

FIG. 1C is a diagram illustrating a visual representation 140 of a message chain according to at least one example embodiment. Visual representation 140 comprises nodes 141, 142, 143, 144, 145, 146, 147, and 148. The horizontal arrangement of nodes may relate to a time stamp. For example, node 142 may have a later time stamp than node 141. Node connector 151 connects node 141 and node 142. Node connector 152 connects node 141 and node 143. Node connector 153 connects node 142 and node 144. Node connector 154 connects node 141 and node 146. Node connector 155 connects node 144 and node 146. Node connector 156 connects node 146 and node 147. Node connector 157 connects node 146 and node 148. Node 141 may be a parent of node 142, a parent of node 143, and a parent of node 146. Node 142, node 143, and node 146 may be children of node 141. Node 142 may be a parent of node 144. Node 144 may be a child of node 142. Node 144 may be a parent of node 146. Node 146 may be a child of node 144. Node 146 may be a parent of node 147 and node 148. Node 147 and node 148 may be children of node 146.

In the example of visual representation 140, nodes 141, 142, 144, 146, 147, and 148 are indicated by a large circle and nodes 143 and 145 are indicated by small circles. Node 144 is further indicated by a white filled circle, which may represent a focus message. The message chain flow associated with visual representation 140 is the message chain flow of the message represented by node 144, which comprises node 144. The message chain flow further comprises nodes 146, 147, and 148, which are recursive children of node 144. The message chain flow further comprises nodes 141 and 142, which are recursive parents of node 144. Indication of a large circle may be indication that the message represented by the node within the message chain flow. Indication of a small circle may be indication that the message represented by the node is outside the message chain flow. Node connectors 151, 153, 155, 156, and 157 are represented as thick connectors, and node connectors 152 and 154 are represented as thin connectors. Indication of a thick connector may indicate a node connector between two nodes that are within the message chain flow. Indication of a thin connector may indicate connection between two nodes, wherein at least on node is outside the message chain flow.

FIG. 1D is a diagram illustrating a visual representation 160 of a message chain according to at least one example embodiment. Visual representation 160 comprises nodes 161, 162, 163, 164, 165, 166, 167, and 168. The horizontal arrangement of nodes may relate to a time stamp. For example, node 162 may have a later time stamp than node 161. Node connector 171 connects node 161 and node 162. Node connector 172 connects node 161 and node 163. Node connector 173 connects node 162 and node 164. Node connector 174 connects node 161 and node 166. Node connector 175 connects node 164 and node 166. Node connector 176 connects node 166 and node 167. Node connector 177 connects node 166 and node 168. Node 161 may be a parent of node 162, a parent of node 163, and a parent of node 166. Node 162, node 163, and node 166 may be children of node 161. Node 162 may be a parent of node 164. Node 164 may be a child of node 162. Node 164 may be a parent of node 166. Node 166 may be a child of node 164. Node 166 may be a parent of node 167 and node 168. Node 167 and node 168 may be children of node 166.

In the example of visual representation 160, nodes 161, 162, 164, 165, 166, 167, and 168 are indicated by a large circle and node 163 is indicated by a small circle. Node 164 is further indicated by a white filled circle, which may represent a focus message. The message chain flow associated with visual representation 160 is the message chain flow of the message represented by node 164, which comprises node 164. The message chain flow further comprises nodes 166, 167, and 168, which are recursive children of node 164. The message chain flow further comprises nodes 161 and 162, which are recursive parents of node 164. Indication of a large circle may be indication that the message represented by the node is within the message chain flow or that the message represented by the node is associated with an attribute. For example, node 165 represents a message outside the message chain flow, but associated with the attribute. Indication of a small circle may be indication that the message represented by the node is outside the message chain flow and that the message represented by the node is unassociated with the attribute. Node connectors 171, 173, 175, 176, and 177 are represented as thick connectors, and node connectors 172 and 174 are represented as thin connectors. Indication of a thick connector may indicate a node connector between two nodes that are within the message chain flow. Indication of a thin connector may indicate connection between two nodes, wherein at least on node is outside the message chain flow.

FIG. 1E is a diagram illustrating a visual representation 180 of a message chain according to at least one example embodiment. Visual representation 180 comprises nodes 181, 182, 183, 184, 185, 186, 187, and 188. The horizontal arrangement of nodes may relate to a time stamp. For example, node 182 may have a later time stamp than node 181. Node connector 191 connects node 181 and node 182. Node connector 192 connects node 181 and node 183. Node connector 193 connects node 182 and node 184. Node connector 194 connects node 181 and node 186. Node connector 195 connects node 184 and node 186. Node connector 196 connects node 186 and node 187. Node connector 197 connects node 186 and node 188. Node 181 may be a parent of node 182, a parent of node 183, and a parent of node 186. Node 182, node 183, and node 186 may be children of node 181. Node 182 may be a parent of node 184. Node 184 may be a child of node 182. Node 184 may be a parent of node 186. Node 186 may be a child of node 184. Node 186 may be a parent of node 187 and node 188. Node 187 and node 188 may be children of node 186.

In the example of visual representation 180, nodes 182, 184, and 187 are indicated by a large circle and nodes 181, 183, 185, 186, and 188 are indicated by small circles. Node 184 is further indicated by a white filled circle, which may represent a focus message. The message chain flow associated with visual representation 180 is the message chain flow of the message represented by node 184, which comprises node 184. The message chain flow further comprises nodes 186, 187, and 188, which are recursive children of node 184. The message chain flow further comprises nodes 181 and 182, which are recursive parents of node 184. Indication of a large circle may be indication that the message represented by the node is associated with an attribute. Indication of a small circle may be indication that the message represented by the node is unassociated with the attribute. For example, node 186 represents a message within the message chain flow, but unassociated with the attribute. Node connectors 191, 193, 195, 196, and 197 are represented as thick connectors, and node connectors 192 and 194 are represented as thin connectors. Indication of a thick connector may indicate a node connector between two nodes that are within the message chain flow. Indication of a thin connector may indicate connection between two nodes, wherein at least on node is outside the message chain flow.

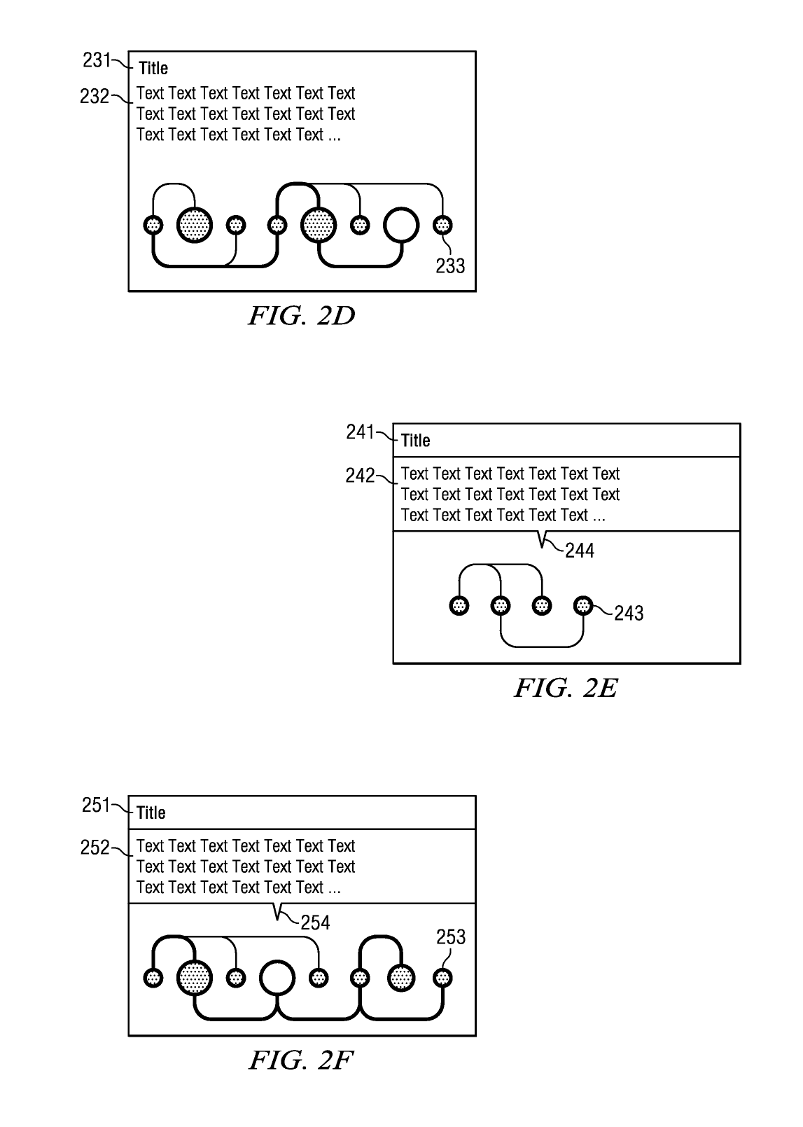

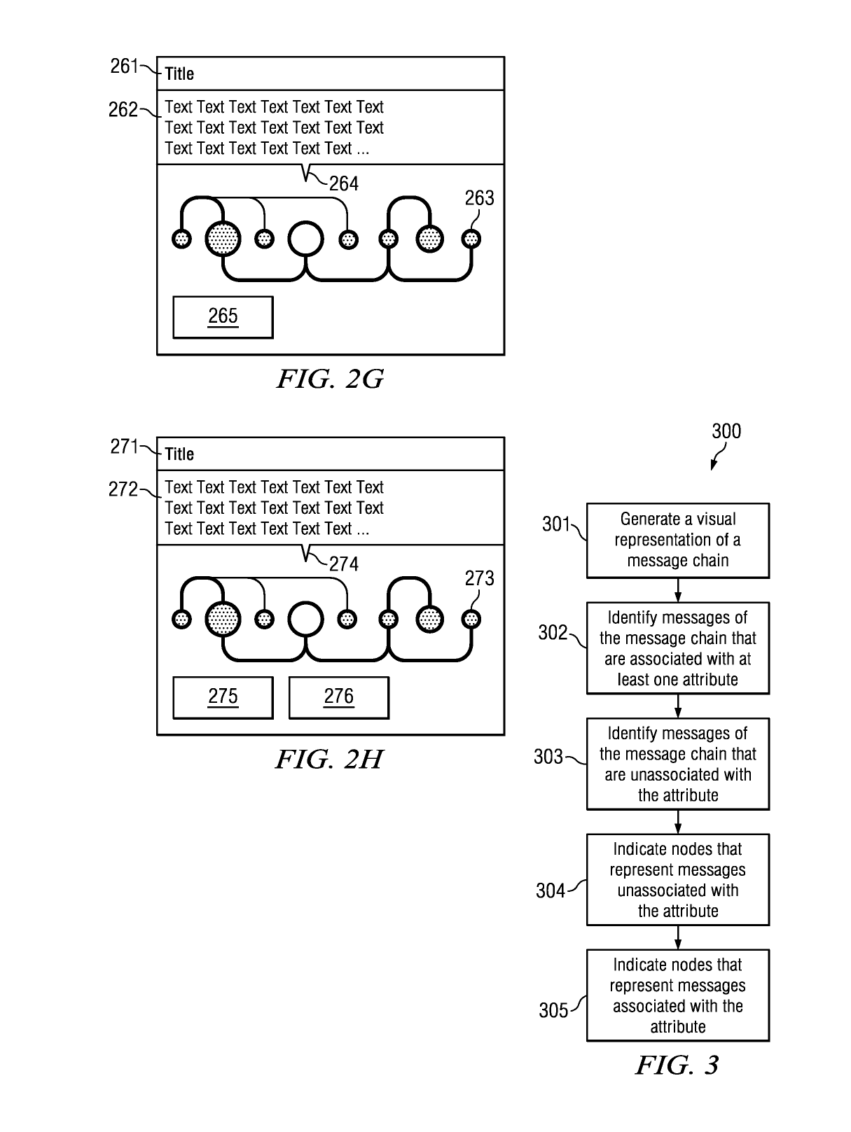

FIGS. 2A-2H are diagrams illustrating visual representations of message information according to at least one example embodiment. The examples of FIGS. 2A-2H are merely examples of visual representations of message information, and do not limit the scope of the claims. For example, arrangement may vary, type of information may vary, size may vary, orientation may vary, and/or the like. Even though the examples of FIGS. 2A-2H comprise visual representations of a message chain, message information may omit representation of a message chain. The examples of FIGS. 2A-2H comprise a title. A title may indicate a subject field, a keyword, a subject header, and/or the like. The message may comprise the title. For example, metadata of the message may comprise a subject field. In such an example, the title may be the subject field. The apparatus may determine a title. For example, the title may be a blog subject field. In such an example, the apparatus may determine a title for the message based on the subject field of the blog. In another example, the apparatus may determine a title based upon an analysis of the message. In such an example, the apparatus may base the title on a key word. The title may allow a user to differentiate between one or more messages, one or more groups of messages, and/or the like.

FIG. 2A is a diagram illustrating a visual representation of message information according to at least one example embodiment. In the example of FIG. 2A, the visual representation of message information comprises a visual representation of a message chain 203 associated with the message information and title 201 associated with the message chain. Title 201 may represent at least part of the title of at least one message of the message chain.

FIG. 2B is a diagram illustrating a visual representation of message information according to at least one example embodiment. In the example of FIG. 2B, the visual representation of message information comprises a title 211, a visual representation of a message chain 213, which indicates a node that represents a focus message, and a date 212. Date 212 may indicate a time stamp associated with the focus message. Title 211 may represent at least part of the title of the focus message.

FIG. 2C is a diagram illustrating a visual representation of message information according to at least one example embodiment. In the example of FIG. 2C, the visual representation of message information comprises a title 221, a visual representation of a message chain 223, which indicates a node that represents a focus message, and a date 222. Date 222 may indicate a time stamp associated with the focus message of message chain 223. Title 221 may represent title of the focus message of message chain 223. In the example of FIG. 2C, the visual representation of message information further comprises a title 224, a visual representation of a message chain 226, which indicates a node that represents a focus message, and a date 225. Date 225 may indicate a time stamp associated with the focus message of message chain 226. Title 224 may represent title of the focus message of message chain 226. In the example of FIG. 2C, the visual representation of message information further comprises a title 227, a visual representation of a message chain 229, which indicates a node that represents a focus message, and a date 228. Date 228 may indicate a time stamp associated with the focus message of message chain 229. Title 227 may represent at least part of the title of the focus message of message chain 229.

FIG. 2D is a diagram illustrating a visual representation of message information according to at least one example embodiment. In the example of FIG. 2D, the visual representation of message information comprises a title 231, a visual representation of a message chain 233, which indicates a node that represents a focus message, and text information 232. Text information 232 may represent at least part of the body of the focus message. Title 231 may represent at least part of the title of the focus message.

FIG. 2E is a diagram illustrating a visual representation of message information according to at least one example embodiment. In the example of FIG. 2E, the visual representation of message information comprises a title 241, a visual representation of a message chain 243, and text information 242. Pointer 244 indicates the focus message of the message chain. Text information 242 may represent at least part of the body of the focus message. Title 241 may represent at least part of the title of the focus message.

FIG. 2F is a diagram illustrating a visual representation of message information according to at least one example embodiment. In the example of FIG. 2F, the visual representation of message information comprises a title 251, a visual representation of a message chain 253, which indicates a node that represents a focus message, and text information 252. Pointer 245 further indicates the focus message of the message chain. Text information 252 may represent at least part of the body of the focus message. Title 251 may represent at least part of the title of the focus message.

FIG. 2G is a diagram illustrating a visual representations of a message chain according to at least one example embodiment. In the example of FIG. 2G, the visual representation of message information comprises a title 261, a visual representation of a message chain 263, which indicates a node that represents a focus message, and text information 262. Pointer 265 further indicates the focus message of the message chain. Text information 262 may represent at least part of the body of the focus message. Title 261 may represent at least part of the title of the focus message. Block 265 indicates an attribute associated with messages represented by nodes of visual representation of message chain 263. Visual representation of message chain 263 may indicate association between a message and the attribute similar as described with reference to FIGS. 1A-1E. The attribute may be selected from a list of attributes. For example, the apparatus may provide a list of attributes, where upon receiving input indicating selection of the attribute, the apparatus generates the visual representation of the message chain with respect to the attribute. In an example embodiment, the list of attributes relate to attributes of a single attribute type. The attribute type of the list of attributes may relate to a predetermined setting, a user setting, a user selection, and/or the like. In an example embodiment, the list of attributes is limited to attributes associated with the focus message. For example, the list of attributes may be limited to message participants that are associated with the focus message.

FIG. 2H is a diagram illustrating a visual representations of a message chain according to at least one example embodiment. In the example of FIG. 2H, the visual representation of message information comprises a title 271, a visual representation of a message chain 273, which indicates a node that represents a focus message, and text information 272. Pointer 275 further indicates the focus message of the message chain. Text information 272 may represent at least part of the body of the focus message. Title 271 may represent at least part of the title of the focus message. Block 275 indicates a non-tag attribute associated with messages represented by nodes of visual representation of message chain 273. Block 276 indicates a tag associated with messages represented by nodes of visual representation of message chain 273. Visual representation of message chain 273 may indicate association between a message and the non-tag attribute and between a message and the tag similar as described with reference to FIGS. 1A-1E. The attribute may be selected from a list of attributes. For example, the apparatus may provide a list of attributes, where upon receiving input indicating selection of the attribute, the apparatus generates the visual representation of the message chain with respect to the attribute. In an example embodiment, the list of attributes relate to attributes of a single attribute type. The attribute type of the list of attributes may relate to a predetermined setting, a user setting, a user selection, and/or the like. In an example embodiment, the list of attributes is limited to attributes associated with the focus method. For example, the list of attributes may be limited to message participants that are associated with the focus message. The tag may be selected from a list of tags. For example, the apparatus may provide a list of tags, where upon receiving input indicating selection of the tag, the apparatus generates the visual representation of the message chain with respect to the tag. In an example embodiment, the list of tags is limited to tags associated with the focus message.

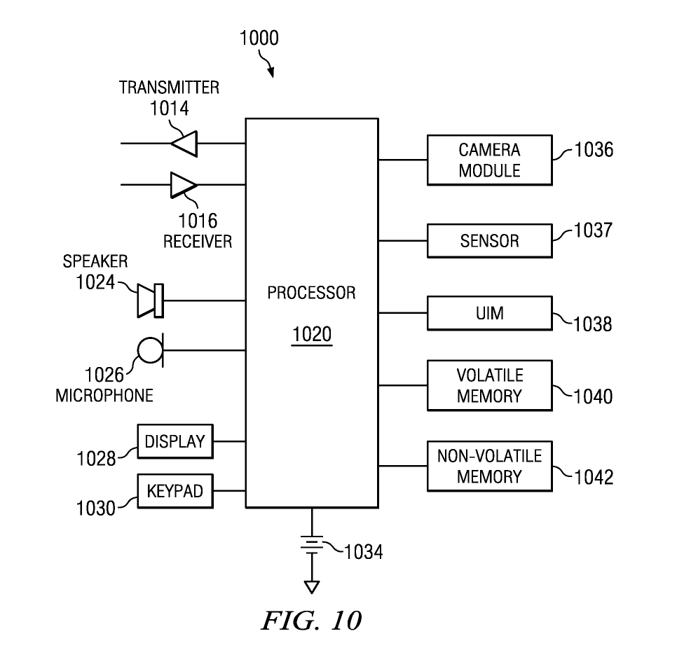

FIG. 3 is a flow diagram showing a set of operations 300 for representing a message chain according to at least one example embodiment. An apparatus, for example electronic device 10 of FIG. 10 or a portion thereof, may utilize the set of operations 300. The apparatus may comprise means, including, for example processor 20 of FIG. 10, for performing the operations of FIG. 3. In an example embodiment, an apparatus, for example device 10 of FIG. 10, is transformed by having memory, for example memory 42 of FIG. 10, comprising computer code configured to, working with a processor, for example processor 20 of FIG. 10, cause the apparatus to perform set of operations 300.

At block 301, the apparatus generates a visual representation of a message chain. The visual representation of the message chain may be similar as described with reference to FIGS. 1A-1E.

At block 302, the apparatus identifies messages of the message chain that are associated with at least one attribute. The attribute and identification of messages that are associated with the attribute may be similar as described with reference to FIGS. 1A-1E.

At block 303, the apparatus identifies messages of the message chain that are unassociated with the attribute. The identification of messages unassociated with the attribute may be similar as described with reference to FIGS. 1A-1E.

At block 304, the apparatus indicates nodes that represent messages unassociated with the attribute, similar as described with reference to FIGS. 1A-1E.

At block 305, the apparatus indicate nodes that represent messages that are associated with the attribute, similar as described with reference to FIGS. 1A-1E.

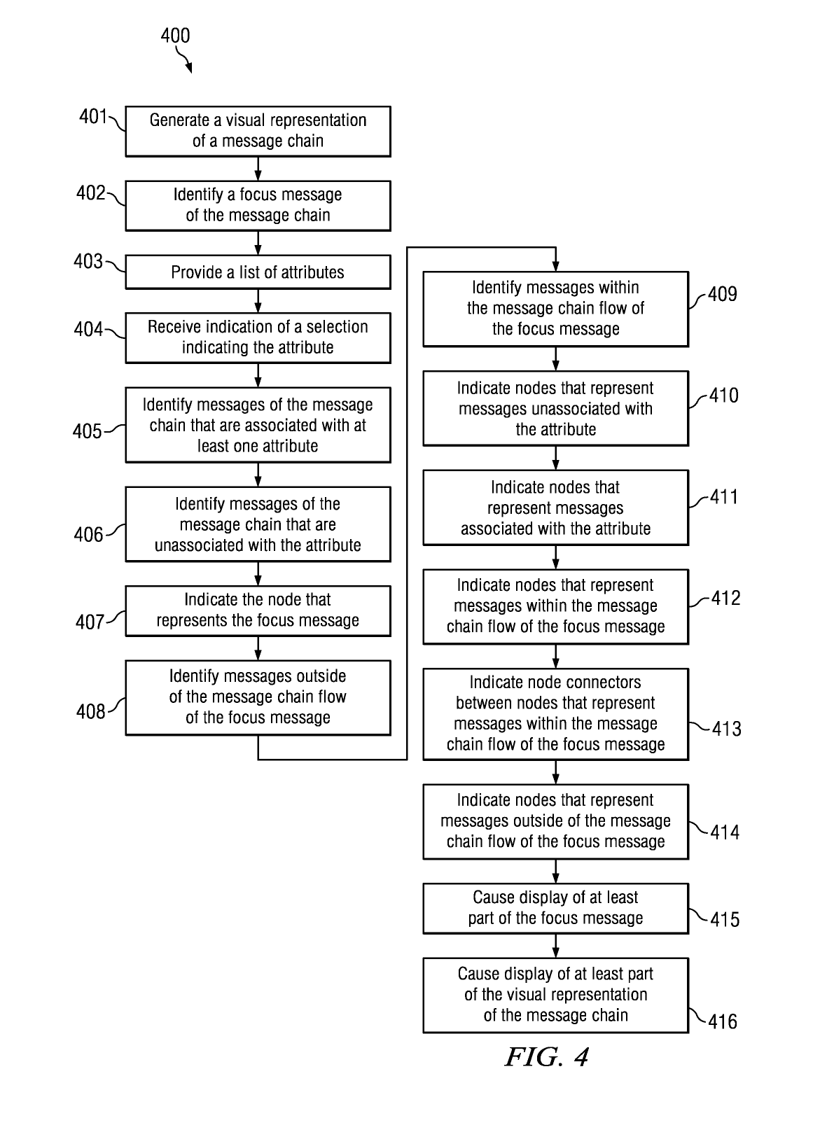

FIG. 4 is a flow diagram showing a set of operations 400 for representing a message chain according to at least one example embodiment. An apparatus, for example electronic device 10 of FIG. 10 or a portion thereof, may utilize the set of operations 400. The apparatus may comprise means, including, for example processor 20 of FIG. 10, for performing the operations of FIG. 4. In an example embodiment, an apparatus, for example device 10 of FIG. 10, is transformed by having memory, for example memory 42 of FIG. 10, comprising computer code configured to, working with a processor, for example processor 20 of FIG. 10, cause the apparatus to perform set of operations 400.

At block 401, the apparatus generates a visual representation of a message chain similar as described with reference to block 301 of FIG. 3.

At block 402, the apparatus identifies a focus message of the message chain. The focus message and identification are similar as described with reference to FIGS. 1A-1E.

At block 403, the apparatus provides a list of attributes, similar as described with reference to FIGS. 2G-2H.

At block 404, the apparatus receives indication of a selection indicating the attribute. The selection may indicate the attribute from the list of attributes similar as described with reference to FIGS. 2G-2H. The apparatus may receive selection from an indication of an input, from a separate apparatus, and/or the like.

At block 405, the apparatus identifies messages of the message chain that are associated with at least one attribute, similar as described with reference to block 302 of FIG. 3.

At block 406, the apparatus identifies messages of the message chain that are unassociated with the attribute, similar as described with reference to block 303 of FIG. 3.

At block 407, the apparatus indicates the node that represents the focus message. Indication of the node that represents the focus message may be similar as described with reference to FIGS. 1A-1E, and FIGS. 2A-2H.

At block 408, the apparatus identifies messages outside of the message chain flow of the focus message, similar as described with reference to FIGS. 1A-1E.

At block 409, the apparatus identifies messages within the message chain flow of the focus message, similar as described with reference to FIGS. 1A-1E.

At block 410, the apparatus indicates nodes that represent messages unassociated with the attribute, similar as described with reference to block 304 of FIG. 3.

At block 411, the apparatus indicates nodes that represent messages that are associated with the attribute, similar as described with reference to block 305 of FIG. 3.

At block 412, the apparatus indicates nodes that represent messages within the message chain flow of the focus message similar as described with reference to FIGS. 1A-1E.

At block 413, the apparatus indicates node connectors between nodes that represent messages within the message chain flow of the focus message, similar as described with reference to FIGS. 1A-1E.

At block 414, the apparatus indicates nodes that represent messages outside of the message chain flow of the focus message, similar as described with reference to FIGS. 1A-1E.

At block 415, the apparatus causes display of at least part of the focus message, similar as described with reference to FIGS. 2A-2H. Causing of display may relate to sending information comprising the at least part of the focus message to a display, such as display 28 of FIG. 10, sending information to an external apparatus, such as an external display, and/or the like.

At block 416, the apparatus causes display of at least part of the visual representation of the message chain. Causing of display may relate to sending information comprising the at least part of the focus message to a display, such as display 28 of FIG. 10, sending information to an external apparatus, such as an external display, and/or the like.

FIGS. 5A-5E are diagrams illustrating visual representations of tag arrangements according to at least one example embodiment. The examples of FIGS. 5A-5E are merely examples of visual representations of tag arrangements, and do not limit the scope of the claims. For example, arrangement may vary, type of information may vary, size may vary, orientation may vary, period may vary, manner of visual association may vary, number of sub-periods may vary, tag representation may vary, and/or the like. Even though the example of FIGS. 5A-5E indicate text for tags and sub-periods, the text is merely used for clarity purposes and does not limit the claim in any way.

Without limiting the scope of the claims in any way, at least one possible technical effects of the visual representations of FIGS. 5A-5E may be to reduce user confusion associated with visual information. At least another possible technical effect may be to improve operational efficiency by reducing amount of navigation from a user desiring information.

In an example embodiment, a user may desire to understand information related to messages. For example, a user may have a large number of messages that have been received and sent over a long period of time. In such an example, the user may desire to view tags associated with the messages.

A tag may be associated with a set of information, such as a message, a document, audio, video, and/or the like. A tag may represent a subset of the set of information. For example, a tag may be a keyword, a recurring word, information associated with a recurring word, an image, an indication of subject matter, and/or the like. An apparatus may associate a tag with a set of information based on an apparatus determination. For example, an apparatus may evaluate a set of information and determine that the set of information relates to an existing tag. Such an evaluation may comprise determining that the tag is present in the set of information, that the set of information comprises information associated with the tag, and/or the like. An apparatus may associate a tag with a set of information based on a user selection. For example, a user may provide input that associates a tag with a set of information, for example, selecting a tag from a list, dragging a tag to an object, and/or the like.

In an example embodiment, an association between a tag and a set of information may be rated by relevance. Relevance may be a measure of how well a tag relates to a set of information. For example, a tag with a strong relation to a set of information may have a high relevance. Conversely, a tag with a weak relation to a set of information may have a low relevance. An apparatus may determine relevance of a tag to a set of information by frequency of occurrence of information within the set of information, similarity between the tag and the set of information, and/or the like.

In an example embodiment, a user may desire to evaluate tags associated with multiple sets of information. For example, the user may desire to view groups of tags that are associated with groups of sets of information. In such an example, the user may be able to find specific information based on the tags. For example, a user may be able to find a specific email via a tag that the user deems to be likely associated with the email. In such an example, the user may be able to view tags that are associated with groups of emails. The groups of sets of information may be based on one or more attributes, a time period, and/or the like. For example, the set of information may relate to a message, and the group may relate to a time period. In such an example the user may view tags that are associated with messages having a message time stamp included by the time period. The time stamp may relate to a time when a message was sent, a time when a message was received, and/or the like. A time stamp may be considered to be included in a time period based on the time stamp being after the beginning of the time period or being equal to the beginning of the time period, and being before the end of the time period or at the end of the time period.

In an example embodiment an apparatus indicates relevance of a tag by basing visual representation of the tag, at least in part, on relevance of the tag. For example, the apparatus may indicate relevance by font size, color, typeset, orientation, position, and/or the like.

FIG. 5A is a diagram illustrating a visual representation of a tag arrangement according to at least one example embodiment. The visual representation of FIG. 5A comprises a visual representation of a time period 505 in relation to a visual representation of selectable time period 504. The selectable time period may span a larger time span than the time period. The time period may be included in the selectable time period. In an example embodiment, demarcation between the visual representation of the time period and the visual representation of the selectable time period 504 is provided by one or more terminus. In the example of FIG. 5A, the left terminus of visual representation of time period 505 may be the left demarcation that serves as a boundary between the left part of visual representation of time period 505 and visual representation of selectable time period 504. The right terminus of the visual representation of time period 505 may be the right demarcation that serves as a boundary between the right part of visual representation of time period 505 and visual representation of selectable time period 504.

Visual representation of sub-period 503 indicates one of a plurality of sub-periods within the time period. In the example, of FIG. 5A, visual representation of sub-period 503 indicates one of 7 sub-periods within the time period. Visual representation of group of tags 501 is visually associated with visual representation of sub-period 503 by being substantially adjacent to visual representation of sub-period 503. The visual representation of group of tags 501 comprises a plurality of visual representation of tags. In the example of FIG. 5A, the tags indicated by the visual representation of tags that comprise visual representation of group of tags 501 are associated with the sub-period indicated by visual representation of sub-period 503. This association may be by virtue of the tags being associated with sets of information, such as messages, that are associated with the sub-period. Visual representation of tag 502 is indicated by a larger font than the lower adjacent visual representation of the tag. Such indication may denote a difference in relevance between these tags.

FIG. 5B is a diagram illustrating a visual representation of a tag arrangement according to at least one example embodiment. The visual representation of FIG. 5B comprises a visual representation of a time period 525 in relation to a visual representation of selectable time period 524. The selectable time period may span a larger time span than the time period. The time period may be included in the selectable time period. In an example embodiment, demarcation between the visual representation of the time period and the visual representation of the selectable time period 524 is provided by one or more terminus. In the example of FIG. 5B, the left terminus of visual representation of time period 525 may be the left demarcation that serves as a boundary between the left part of visual representation of time period 525 and visual representation of selectable time period 524. The right terminus of the visual representation of time period 525 may be the right demarcation that the right end of visual representation of time period 525 has similarly located with the right end of visual representation of selectable time period 524.

Visual representation of sub-period 523 indicates one of a plurality of sub-periods within the time period. In the example, of FIG. 5B, visual representation of sub-period 523 indicates one of 7 sub-periods within the time period. Visual representation of group of tags 521 is visually associated with visual representation of sub-period 523 by being substantially adjacent to visual representation of sub-period 523. The visual representation of group of tags 521 comprises a plurality of visual representation of tags. In the example of FIG. 5B, the tags indicated by the visual representation of tags that comprise visual representation of group of tags 521 are associated with the sub-period indicated by visual representation of sub-period 523. This association may be by virtue of the tags being associated with sets of information, such as messages, that are associated with the sub-period. Visual representation of tag 522 is indicated by a larger font than the lower adjacent visual representation of the tag. Such indication may denote a difference in relevance between these tags.

The visual representation of FIG. 5B comprises a representation of a message volume time chart 526. The message volume time chart may indicate message volume corresponding to a time within the time period. The message volume time chart 526 may be positioned such that sub-periods substantially align with a part of the message volume time chart that corresponds to the same part of the time period as the sub period.

FIG. 5C is a diagram illustrating a visual representation of a tag arrangement according to at least one example embodiment. The visual representation of FIG. 5C comprises a visual representation of a time period 545 in relation to a visual representation of selectable time period 544. The selectable time period may span a larger time span than the time period. The time period may be included in the selectable time period. In an example embodiment, demarcation between the visual representation of the time period and the visual representation of the selectable time period is provided by one or more terminus. In the example of FIG. 5C, the left terminus of visual representation of time period 545 may be the left demarcation that serves as a boundary between the left part of visual representation of time period 545 and visual representation of selectable time period 544. The right terminus of the visual representation of time period 545 may be the right demarcation that serves as a boundary between the right part of visual representation of time period 545 and visual representation of selectable time period 544.

Visual representation of sub-period 543 indicates one of a plurality of sub-periods within the time period. In the example, of FIG. 5C, visual representation of sub-period 543 indicate one of 7 sub-periods within the time period. Visual representation of group of tags 541 is visually associated with visual representation of sub-period 543 by being substantially adjacent to visual representation of sub-period 543. The visual representation of group of tags 541 comprises a plurality of visual representation of tags. In the example of FIG. 5C, the tags indicated by the visual representation of tags that comprise visual representation of group of tags 541 are associated with the sub-period indicated by visual representation of sub-period 543. This association may be by virtue of the tags being associated with sets of information, such as messages, that are associated with the sub-period. Visual representation of tag 542 is indicated by a larger font than the lower adjacent visual representation of the tag. Such indication may denote a difference in relevance between these tags.

The visual representation of FIG. 5C comprises a period adjustment indicator 547. Period adjustment indicator 547 may indicate that a user may adjust the time period by performing input in relation to period adjustment indicator 547.

FIG. 5D is a diagram illustrating a visual representation of a tag arrangement according to at least one example embodiment. The visual representation of FIG. 5D comprises a visual representation of a time period 571 in relation to a visual representation of selectable time period 570. The selectable time period may span a larger time span than the time period. The time period may be included in the selectable time period. In an example embodiment, demarcation between the visual representation of the time period and the visual representation of the selectable time period is provided by one or more terminus. In the example of FIG. 5D, the left terminus of visual representation of time period 571 may be the left demarcation that serves as a boundary between the left part of visual representation of time period 571 and visual representation of selectable time period 570. The right terminus of the visual representation of time period 571 may be the right demarcation that serves as a boundary between the right part of visual representation of time period 571 and visual representation of selectable time period 570.

Visual representation of sub-period 563 indicates one of a plurality of sub-periods within the time period. In the example, of FIG. 5D, visual representation of sub-period 563 indicate one of 7 sub-periods within the time period. Visual representation of group of tags 561 is visually associated with visual representation of sub-period 563 by being substantially adjacent to visual representation of sub-period 563. The visual representation of group of tags 561 comprises a plurality of visual representation of tags. In the example of FIG. 5D, the tags indicated by the visual representation of tags that comprise visual representation of group of tags 561 are associated with the sub-period indicated by visual representation of sub-period 563. This association may be by virtue of the tags being associated with sets of information, such as messages, that are associated with the sub-period. Visual representation of tag 562 is indicated by a larger font than the lower adjacent visual representation of the tag. Such indication may denote a difference in relevance between these tags.

The visual representation of selectable time period 570 comprises a representation of a message volume time chart. The message volume time chart may indicate message volume corresponding to a time within the time period. The message volume time chart may be positioned such that sub-periods substantially align with a part of the message volume time chart that corresponds to the same part of the time period as the sub period.

FIG. 5E is a diagram illustrating a visual representation of a tag arrangement according to at least one example embodiment. The visual representation of FIG. 5E comprises a visual representation of a time period 585 in relation to a visual representation of selectable time period 584. The selectable time period may span a larger time span than the time period. The time period may be included in the selectable time period. In an example embodiment, demarcation between the visual representation of the time period and the visual representation of the selectable time period is provided by one or more terminus. In the example of FIG. 5E, the left terminus of visual representation of time period 585 may be the left demarcation that serves as a boundary between the left part of visual representation of time period 585 and visual representation of selectable time period 584. The right terminus of the visual representation of time period 585 may be the right demarcation that the right end of visual representation of time period 585 has similarly located with the right end of visual representation of selectable time period 584.

Visual representation of sub-period 583 indicates one of a plurality of sub-periods within the time period. In the example, of FIG. 5E, visual representation of sub-period 583 indicate one of 7 sub-periods within the time period. Visual representation of group of tags 581 is visually associated with visual representation of sub-period 583 by being substantially adjacent to visual representation of sub-period 583. The visual representation of group of tags 581 comprises a plurality of visual representation of tags. In the example of FIG. 5E, the tags indicated by the visual representation of tags that comprise visual representation of group of tags 581 are associated with the sub-period indicated by visual representation of sub-period 583. This association may be by virtue of the tags being associated with sets of information, such as messages, that are associated with the sub-period. Visual representation of tag 582 is indicated by a larger font than the lower adjacent visual representation of the tag. Such indication may denote a difference in relevance between these tags.

The visual representation of FIG. 5E comprises a representation of a message volume time chart 586. The message volume time chart may indicate message volume corresponding to a time within the time period. The message volume time chart 586 may be positioned such that sub-periods substantially align with a part of the message volume time chart that corresponds to the same part of the time period as the sub period.

The visual representation of FIG. 5E comprises a visual representation of a time period 591 in relation a visual representation of selectable time period 590. The selectable time period may span a larger time span than the time period. The time period may be included in the selectable time period. In an example embodiment, demarcation between the visual representation of the time period and the visual representation of the selectable time period is provided by one or more terminus. The visual representation of selectable time period 590 comprises a representation of a message volume time chart. The message volume time chart may indicate message volume corresponding to a time within the time period. The message volume time chart may be positioned such that sub-periods substantially align with a part of the message volume time chart that corresponds to the same part of the time period as the sub period.

In the example of FIG. 5E, the left terminus of visual representation of time period 591 may be the left demarcation that serves as a boundary between the left part of visual representation of time period 591 and visual representation of selectable time period 590. The right terminus of the visual representation of time period 591 may be the right demarcation that serves as a boundary between the right part of visual representation of time period 591 and visual representation of selectable time period 590.

The visual representation of FIG. 5E comprises a period adjustment indicator 592 and a period adjustment indicator 593. Period adjustment indicators 592 and 593 may indicate that a user may adjust the time period by performing input in relation to period adjustment indicator 592 and/or period adjustment indicator 593.

In an example embodiment, an apparatus may limit tags represented in the visual representation according to an attribute associated with the sets of information with which the tags are associated. For example, the apparatus may represent only tags that are associated with sets of information that are associated with an attribute. In such an example, where an attribute relates to a sender of a message, the apparatus may omit representations of tags that are unassociated with messages from the sender. In an example embodiment, the apparatus identifies a set of messages that comprise the attribute and the represented tags consist of tags that are associated with a message comprised in the set of messages. In an example embodiment, the representation comprises an indication of the attribute, such as attribute indication 595.

In an example embodiment, a user may modify the time period of the visual representation. For example, the user may adjust the time span of the time period. In such an example, the user may perform input that causes the time span of the time period prior to receiving the input to differ from the time span of the time period after the input.

In an example embodiment, a user may shift the time period of the visual representation. For example, the user may adjust the start point and the end point of the time period so that the midpoint of the time period. In such an example, the user may perform input that causes the midpoint of the time period to differ from the midpoint of the time period after the input. In an example embodiment, time period shifting is characterized by the start point and the end point of the time period changing in substantially the same direction. In another example embodiment, time period shifting is characterized by the start point and the end point of the time period changing in substantially the same direction by substantially the same time.

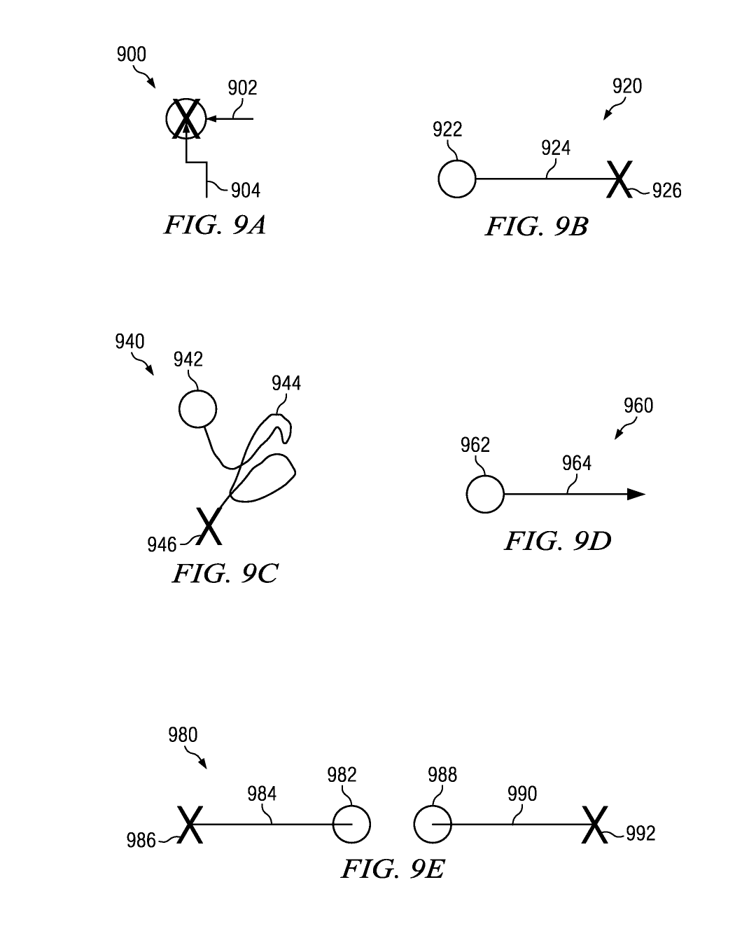

In an example embodiment, an apparatus may receive indication of an input associated with a selectable time period, such as selectable time period 504 of FIG. 5A. The input may be associated with a terminus of a time period representation, such as the left terminus of time period representation 525 of FIG. 5B, the right terminus of time period representation 571 of FIG. 5D, and/or the like. For example, the input may comprise position information corresponding to position of the terminus, a menu selection relating to the terminus, and/or the like. The apparatus may determine a different time period based, at least in part on the input. For example, the apparatus may determine a time period having a different start point that corresponds to an input indicating a change in a left terminus of a time period. The apparatus may determine different sub-periods that correspond to the different time period. For example, the sub-periods prior to receiving the input may differ by time span, start point, end point, and/or the like. In an example embodiment, the number of sub-periods prior to receiving the input may differ from the number of sub-periods after the input. The apparatus may base determination of the sub periods on a presentation directive, a data organization directive, and/or the like. A presentation directive may relate to a desired minimum and/or maximum number of sub-periods for a time period. A data organization directive may relate to determining sub-periods that correspond to time information associated with the tags. For example, tag relevance may be determined in correspondence with a one-week time. In such an example, the apparatus may determine sub-periods based on a one-week granularity. Such determination may allow the apparatus to utilize previously determined relevance information. The input may relate to a period adjustment indicator, such as period adjustment indicator 592 of FIG. 5E. For example, the input may correspond to a position substantially coinciding with a position of a period adjustment indicator. The input may relate to a touch input, such as touch input 920 of FIG. 9B, touch input 980 of FIG. 9E, and/or the like.

In an example embodiment, an apparatus may receive indication of an input associated with both termini of the time period. The apparatus may determine that such an input is associated with a time period shift, a time span change, and/or the like. The input may relate to a period adjustment indicator, such as period adjustment indicator 592 and period adjustment indicator 593 of FIG. 5E. For example, the input may correspond to a position substantially coinciding with a position of a period adjustment indicator. The input may relate to a touch input, such as touch input 980 of FIG. 9E.

In an example embodiment, an apparatus may receive indication of an input associated with shifting the time period. For example, the input may relate to a position between the left terminus of the time period representation and the right terminus of the time period representation. The apparatus may determine a different time period based, at least in part on the input. For example, the apparatus may determine a time period having a different start point that corresponds to a change indicated by the input in the left terminus of the time period and in the right terminus of the time period. The apparatus may determine different sub-periods that correspond to the different time period. For example, the sub-periods prior to receiving the input may differ by time span, start point, end point, and/or the like. In an example embodiment, the number of sub-periods prior to receiving the input may differ from the number of sub-periods after the input. The apparatus may base determination of the sub periods on a presentation directive, a data organization directive, and/or the like. A presentation directive may relate to a desired minimum and/or maximum number of sub-periods for a time period. A data organization directive may relate to determining sub-periods that correspond to time information associated with the tags. For example, tag relevance may be determine in correspondence with a one-week time. In such an example, the apparatus may determine sub-periods based on a one-week granularity. Such determination may allow the apparatus to utilize previously determined relevance information. The input may relate to a period adjustment indicator, such as period adjustment indicator 547 of FIG. 5C. For example, the input may correspond to a position substantially coinciding with a position of a period adjustment indicator. The input may relate to a touch input, such as touch input 920 of FIG. 9B, touch input 940 of FIG. 9C, and/or the like.

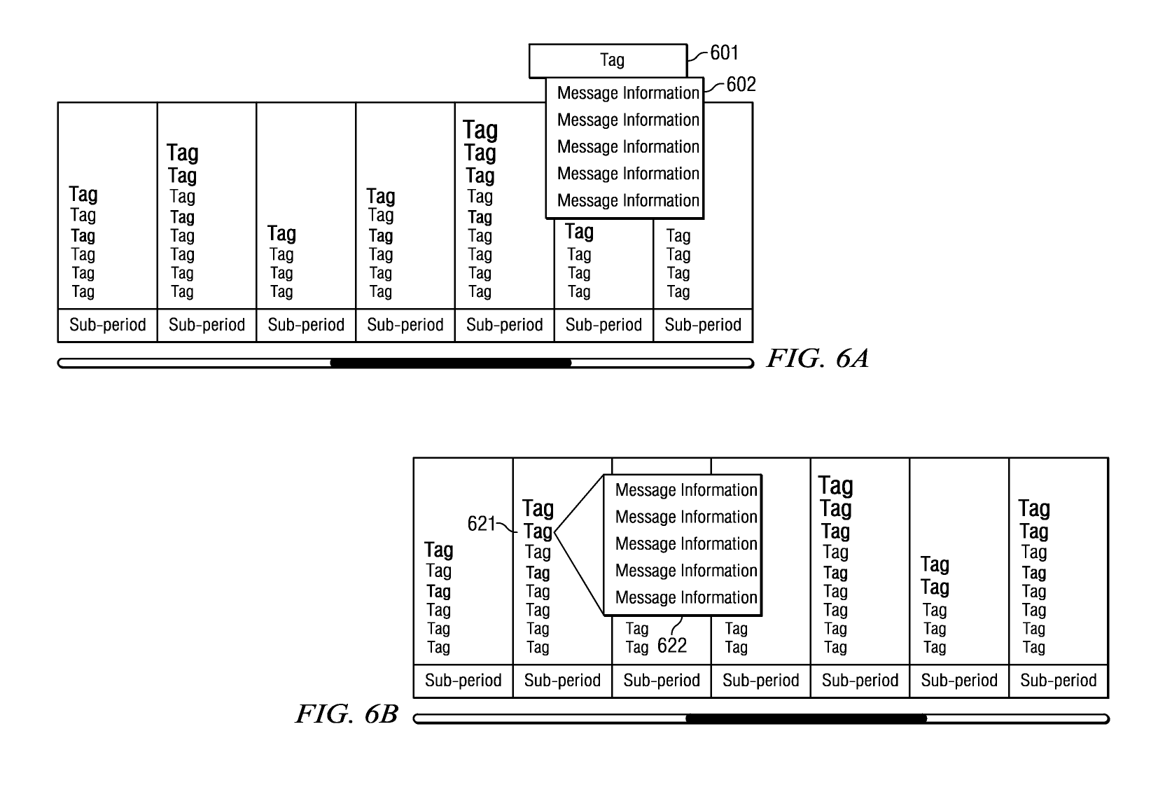

FIGS. 6A-6B are diagrams illustrating visual representations of message information associated with a tag according to at least one example embodiment. The examples of FIGS. 6A-6B are merely examples of visual representations of tag arrangements, and do not limit the scope of the claims. For example, arrangement may vary, type of information may vary, size may vary, orientation may vary, and/or the like.

In an example embodiment, an apparatus receives indication of an input associated with selecting a tag. Input associated with selecting a tag may be input associated with a visual representation of a tag, input associated with selecting a tag from a list, and/or the like. For example, input associated with selecting a tag may relate to an input comprising a position that substantially corresponds to a visual representation of a tag. The indication of the input may relate to a touch input, such as touch input 900 of FIG. 9A, touch input 920 of FIG. 9B, and/or the like.

In an example embodiment, an apparatus provides a visual representation of message information associated with a tag. The visual representation of the message information may be similar as described with reference to FIGS. 2A-2H. Even though the examples of FIGS. 6A-6B indicate a list orientation of message information, the orientation and representation of the message information may vary. The message information may relate to message information associated with a tag within a single sub-period, message information associated with a tag within a plurality of sub-periods, message information associated with a tag within the entirety of a time period, and/or the like. The apparatus may determine message information that is associated with the tag within a single sub-period, message information associated with a tag within a plurality of sub-periods, message information associated with a tag within the entirety of a time period, and/or the like. In an example embodiment, a change in time period, similar as described with reference to FIGS. 5A-5E, may impact sub-period and/or time period associated with the message information.

FIG. 6A is a diagram illustrating a visual representation of message information associated with a tag according to at least one example embodiment. The example of FIG. 6A indicates a visual representation of a selected tag 601. The tag may have been selected from a list, such as a menu, a drop-down list, and/or the like. In the example of FIG. 6A, visual representation of message information 602 associated with the selected tag is provided substantially adjacent to visual representation of selected tag 601. However, position of message information may vary. In an example embodiment, the apparatus indicates tags in the visual representation that correspond to the selected tag. For example, the apparatus may represent tags that correspond to the selected tag by a different color, size, font, shape, highlight, and/or the like, that differs from the representation of tags that fail to correspond to the selected tag.

FIG. 6B is a diagram illustrating a visual representation of message information associated with a tag according to at least one example embodiment. The example of FIG. 6B indicates a visual representation of a selected tag 621. The tag may have been selected in relation to the visual representation of the tag within the sub-period, for example by a touch input. In the example of FIG. 6A, visual representation of message information 622 associated with the selected tag is provided substantially adjacent to visual representation of selected tag 601. However, position of message information may vary. In the example of FIG. 6B, the visual representation of message information comprises a pointing indicator that provides a visual association between the visual representation of selected tag 621 and the visual representation of message information 622. However, the visual association may vary.

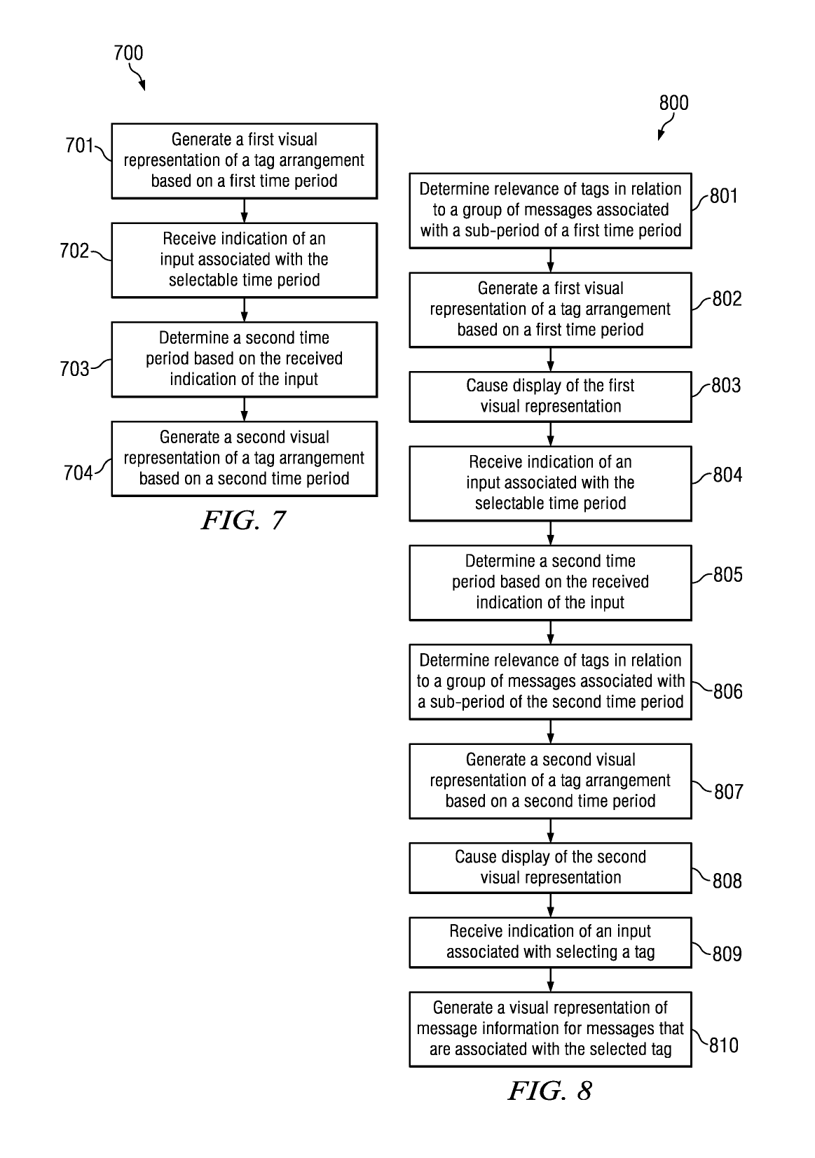

FIG. 7 is a flow diagram showing a set of operations 700 for representing a message chain according to at least one example embodiment. An apparatus, for example electronic device 10 of FIG. 10 or a portion thereof, may utilize the set of operations 700. The apparatus may comprise means, including, for example processor 20 of FIG. 10, for performing the operations of FIG. 7. In an example embodiment, an apparatus, for example device 10 of FIG. 10, is transformed by having memory, for example memory 42 of FIG. 10, comprising computer code configured to, working with a processor, for example processor 20 of FIG. 10, cause the apparatus to perform set of operations 700.

At block 701, the apparatus generates a first visual representation. The first visual representation may be similar as described with reference to FIGS. 5A-5E and FIGS. 6A-6B.

At block 702, the apparatus receives indication of an input associated with the selectable time period. The apparatus may receive indication of the input by retrieving information from one or more memories, such as non-volatile memory 42 of FIG. 10, receiving one or more indications of the input from a part of the apparatus, such as a touch display, for example display 28 of FIG. 10, receiving indication of the input from a receiver, such as receiver 16 of FIG. 10, receiving input from a separate device, a separate touch display, and/or the like. The indication of the input may be similar as described with reference to FIGS. 5A-5E.

At block 703, the apparatus determines a second time period based at least in part on the received indication of the input. The determination of the second time period may be similar as described with reference to FIGS. 5A-5E. The apparatus may determine second plurality of sub-periods within the second time period, similar as described with reference fo FIGS. 5A-5E. In an example embodiment, the apparatus performs block 703 in response to at least a part of block 702.

At block 704, the apparatus generates a second visual representation based, at least in part, on the second time period, similar as described with reference to FIGS. 5A-5E.

FIG. 8 is a flow diagram showing a set of operations 800 for representing a message chain according to at least one example embodiment. An apparatus, for example electronic device 10 of FIG. 10 or a portion thereof, may utilize the set of operations 800. The apparatus may comprise means, including, for example processor 20 of FIG. 10, for performing the operations of FIG. 8. In an example embodiment, an apparatus, for example device 10 of FIG. 10, is transformed by having memory, for example memory 42 of FIG. 10, comprising computer code configured to, working with a processor, for example processor 20 of FIG. 10, cause the apparatus to perform set of operations 800.

At block 801, the apparatus determines relevance of tags in relation to a group of messages that are associated with a sub-period of the first time period. The determination of relevance may be similar as described with reference to FIGS. 5A-5E.

At block 802, the apparatus generates a first visual representation. The first visual representation may be similar as described with reference to block 701 of FIG. 7.

At block 803, the apparatus causes display of the first visual representation. Causing display may relate to sending information comprising the first visual representation to a display, such as display 28 of FIG. 10, sending information to an external apparatus, such as an external display, and/or the like.

At block 804, the apparatus receives indication of an input associated with the selectable time period, similar as described with reference to block 702 of FIG. 7.

At block 805, the apparatus determines a second time period based at least in part on the received indication of the input similar as described with reference to block 703 of FIG. 7.

At block 806, the apparatus determines relevance of tags in relation to a group of messages that are associated with a sub-period of the second time period. The determination of relevance may be similar as described with reference to block 801.

At block 807, the apparatus generates a second visual representation based, at least in part, on the second time period, similar as described with reference to block 704 of FIG. 7.

At block 808, the apparatus causes display of the second visual representation similar as described with reference to block 803.

At block 809, the apparatus receives indication of an input associated with selecting a tag. The receiving of the indication of the input may be similar as described with reference to block 702 of FIG. 7. The input associated with selecting a tag may be similar as described with reference to FIGS. 6A-6B.

At block 810, the apparatus generates a visual representation of message information for messages that are associated with the selected tag. The visual representation of the message information may be similar as described with reference to FIGS. 6A-6B. In an example embodiment, the apparatus performs block 810 in response to performing at least a part of block 809.

FIGS. 9A-9E are diagrams illustrating input associated with a touch display, for example from display 28 of FIG. 8, according to at least one example embodiment. In FIGS. 9A-9E, a circle represents an input related to contact with a touch display, two crossed lines represent an input related to releasing a contact from a touch display, and a line represents input related to movement on a touch display. Although the examples of FIGS. 9A-9E indicate continuous contact with a touch display, there may be a part of the input that fails to make direct contact with the touch display. Under such circumstances, the apparatus may, nonetheless, determine that the input is a continuous stroke input. For example, the apparatus may utilize proximity information, for example information relating to nearness of an input implement to the touch display, to determine part of a touch input.

In the example of FIG. 9A, input 900 relates to receiving contact input 902 and receiving a release input 904. In this example, contact input 902 and release input 904 occur at the same position. In an example embodiment, an apparatus utilizes the time between receiving contact input 902 and release input 904. For example, the apparatus may interpret input 900 as a tap for a short time between contact input 902 and release input 904, as a press for a longer time between contact input 902 and release input 904, and/or the like.

In the example of FIG. 9B, input 920 relates to receiving contact input 922, a movement input 924, and a release input 926. Input 920 relates to a continuous stroke input. In this example, contact input 922 and release input 926 occur at different positions. Input 920 may relate to dragging an object from one position to another, to moving a scroll bar, to panning a virtual screen, to drawing a shape, and/or the like. In an example embodiment, an apparatus interprets input 920 based at least in part on the speed of movement 924. For example, if input 920 relates to panning a virtual screen, the panning motion may be small for a slow movement, large for a fast movement, and/or the like. In another example embodiment, an apparatus interprets input 920 based at least in part on the distance between contact input 922 and release input 926. For example, if input 920 relates to a scaling operation, such as resizing a box, the scaling may relate to the distance between contact input 922 and release input 926. An apparatus may interpret the input before receiving release input 926. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 9C, input 940 relates to receiving contact input 942, a movement input 944, and a release input 946 as shown. Input 940 relates to a continuous stroke input. In this example, contact input 942 and release input 946 occur at different positions. Input 940 may relate to dragging an object from one position to another, to moving a scroll bar, to panning a virtual screen, to drawing a shape, and/or the like. In an example embodiment, an apparatus interprets input 940 based at least in part on the speed of movement 944. For example, if input 940 relates to panning a virtual screen, the panning motion may be small for a slow movement, large for a fast movement, and/or the like. In another example embodiment, an apparatus interprets input 940 based at least in part on the distance between contact input 942 and release input 946. For example, if input 940 relates to a scaling operation, such as resizing a box, the scaling may relate to the distance between contact input 942 and release input 946. In still another example embodiment, the apparatus interprets the position of the release input. In such an example, the apparatus may modify a text selection point based at least in part on the change in the touch input.

In the example of FIG. 9D, input 960 relates to receiving contact input 962, and a movement input 964, where contact is released during movement. Input 960 relates to a continuous stroke input. Input 960 may relate to dragging an object from one position to another, to moving a scroll bar, to panning a virtual screen, to drawing a shape, and/or the like. In an example embodiment, an apparatus interprets input 960 based at least in part on the speed of movement 964. For example, if input 960 relates to panning a virtual screen, the panning motion may be small for a slow movement, large for a fast movement, and/or the like. In another example embodiment, an apparatus interprets input 960 based at least in part on the distance associated with the movement input 964. For example, if input 960 relates to a scaling operation, such as resizing a box, the scaling may relate to the distance of the movement input 964 from the contact input 962 to the release of contact during movement.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 9E, input 980 relates to receiving contact inputs 982 and 988, movement inputs 984 and 990, and release inputs 986 and 992. Input 920 relates to two continuous stroke inputs. In this example, contact input 982 and 988, and release input 986 and 992 occur at different positions. Input 980 may be characterized as a multiple touch input. Input 980 may relate to dragging an object from one position to another, to moving a scroll bar, to panning a virtual screen, to drawing a shape, to indicating one or more user selected text positions and/or the like. In an example embodiment, an apparatus interprets input 980 based at least in part on the speed of movements 984 and 990. For example, if input 980 relates to zooming a virtual screen, the zooming motion may be small for a slow movement, large for a fast movement, and/or the like. In another example embodiment, an apparatus interprets input 980 based at least in part on the distance between contact inputs 982 and 988 and release inputs 986 and 992. For example, if input 980 relates to a scaling operation, such as resizing a box, the scaling may relate to the collective distance between contact inputs 982 and 988 and release inputs 986 and 992.

In an example embodiment, the timing associated with the apparatus receiving contact inputs 982 and 988, movement inputs 984 and 990, and release inputs 986 and 992 varies. For example, the apparatus may receive contact input 982 before contact input 988, after contact input 988, concurrent to contact input 988, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

FIG. 10 is a block diagram showing an apparatus, such as an electronic device 10, according to at least one example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention. Moreover, the apparatus of an example embodiment need not be the entire electronic device, but may be a component or group of components of the electronic device in other example embodiments.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna, (or multiple antennae), a wired connector, and/or the like in operable communication with a transmitter 14 and a receiver 16. The electronic device 10 may further comprise a processor 20 or other processing circuitry that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with wireline protocols, such as Ethernet, digital subscriber line (DSL), asynchronous transfer mode (ATM), second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry, for implementing audio, video, communication, navigation, logic functions, and/or the like, as well as for implementing embodiments of the invention including, for example, one or more of the functions described in conjunction with FIGS. 1A-10. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1A-10. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 1A-10. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. Display 28 may display two-dimensional information, three-dimensional information and/or the like.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1A-10. For example, the memories may comprise an identifier, such as an international mobile equipment identification (IMEI) code, which may uniquely identify the electronic device 10.

Electronic device 10 may comprise one or more sensor 37. Sensor 37 may comprise a light sensor, a proximity sensor, a motion sensor, a location sensor, and/or the like. For example, sensor 37 may comprise one or more light sensors at various locations on the device. In such an example, sensor 37 may provide sensor information indicating an amount of light perceived by one or more light sensors. Such light sensors may comprise a photovoltaic element, a photoresistive element, a charge coupled device (CCD), and/or the like. In another example, sensor 37 may comprise one or more proximity sensors at various locations on the device. In such an example, sensor 37 may provide sensor information indicating proximity of an object, a user, a part of a user, and/or the like, to the one or more proximity sensors. Such proximity sensors may comprise capacitive measurement, sonar measurement, radar measurement, and/or the like.

Although FIG. 10 illustrates an example of an electronic device that may utilize embodiments of the invention including those described and depicted, for example, in FIGS. 1A-10, electronic device 10 of FIG. 10 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 10. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 302 of FIG. 3 may be performed after block 303 of FIG. 3. Furthermore, if desired, one or more of the above-described functions may be optional or may be combined. For example, blocks 403 and 404 of FIG. 4 may be optional and/or combined with block 405.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
a processor;
memory including computer program code, the memory and the computer program code configured to, working with the processor, cause the apparatus to perform at least the following:
generating a first visual representation comprising
a visual representation of a first time period,
a visual representation of a first plurality of sub-periods within the first time period, wherein the visual representation of each sub-period of the first plurality of sub-periods is visually associated with a visual representation of tags that are associated with the each sub-period of the first plurality of sub-periods, and
a visual representation of a selectable time period, wherein the selectable time period includes the first time period;
receiving indication of an input associated with the selectable time period;
in response to receiving indication of the input, determining a second time period and a second plurality of sub-periods within the second time period based at least in part on the received indication of the input; and
generating a second visual representation comprising
a visual representation of the second time period,
a visual representation of the second plurality of sub-periods, wherein the visual representation of each sub-period of the second plurality of sub-periods is visually associated with a visual representation of tags that are associated with the each sub-period of the second plurality of sub-periods, and
a visual representation of the selectable time period, wherein the selectable time period includes the second time period.

2. The apparatus of claim 1, wherein time span of the first time period differs from time span of the second time period.

3. The apparatus of claim 1, wherein the tags are associated with messages.

4. The apparatus of claim 3, wherein the second visual representation comprises a representation of a message volume time chart based at least in part on the second time period.

5. The apparatus of claim 3, wherein the memory and the computer program code are further configured to, working with the processor, cause the apparatus to perform determining relevance of tags in relation to a group of messages wherein the group of messages is based, at least in part, message transmission time being included by a sub-period of the second plurality of sub-periods.

6. The apparatus of claim 5, wherein the visual representation of tags that are associated with the each sub-period of the second plurality of sub-periods indicates determined relevance.

7. The apparatus of claim 3, wherein the memory and the computer program code are further configured to, working with the processor, cause the apparatus to perform identifying a set messages that comprise an attribute, and the tags consist of tags that are associated with a message comprised in the set of messages.

8. The apparatus of claim 7, wherein the second visual representation indicates the attribute.

9. The apparatus of claim 3, wherein the memory and the computer program code are further configured to, working with the processor, cause the apparatus to perform, in response to receiving indication of an input associated with selecting a tag, generating a visual representation of message information for messages that are associated with the selected tag.

10. The apparatus of claim 9, wherein the visual representation of messages comprises a visual representation of a message chain.

11. The apparatus of claim 1, wherein the memory and the computer program code are further configured to, working with the processor, cause the apparatus to perform causing display of at least one of the first visual representation and the second visual representation.

12. The apparatus of claim 11, further comprising a display and the causing display relates to the display.

13. The apparatus of claim 1, wherein the input associated with the selectable time period relates to shifting of the visual representation of the first time period, and the second time period is based, at least in part, on the shifting.

14. The apparatus of claim 1, wherein the input associated with the selectable time period relates to changing a terminus associated with the first time period, and the second time period is based at least in part on the changed terminus.

15. The apparatus of claim 1, wherein the first visual representation comprises at least one period adjustment indicator, and the input relates to the period adjustment indicator.

16. The apparatus of claim 1, wherein the input comprises a touch input.

17. The apparatus of claim 16, wherein the touch input relates to at least one continuous stroke input.

18. The apparatus of claim 1, wherein the apparatus is a mobile computer.

19. A method, comprising:
generating a first visual representation comprising
a visual representation of a first time period,
a visual representation of a first plurality of sub-periods within the first time period, wherein the visual representation of each sub-period of the first plurality of sub-periods is visually associated with a visual representation of tags that are associated with the each sub-period of the first plurality of sub-periods, and
a visual representation of a selectable time period, wherein the selectable time period includes the first time period;
receiving indication of an input associated with the selectable time period;
in response to receiving indication of the input, determining a second time period and a second plurality of sub-periods within the second time period based at least in part on the received indication of the input; and
generating a second visual representation comprising
a visual representation of the second time period,
a visual representation of the second plurality of sub-periods, wherein the visual representation of each sub-period of the second plurality of sub-periods is visually associated with a visual representation of tags that are associated with the each sub-period of the second plurality of sub-periods, and
a visual representation of the selectable time period, wherein the selectable time period includes the second time period

20. A computer-readable medium encoded with instructions that, when executed by a computer, perform:
generating a first visual representation comprising
a visual representation of a first time period,
a visual representation of a first plurality of sub-periods within the first time period, wherein the visual representation of each sub-period of the first plurality of sub-periods is visually associated with a visual representation of tags that are associated with the each sub-period of the first plurality of sub-periods, and
a visual representation of a selectable time period, wherein the selectable time period includes the first time period;
receiving indication of an input associated with the selectable time period;
in response to receiving indication of the input, determining a second time period and a second plurality of sub-periods within the second time period based at least in part on the received indication of the input; and
generating a second visual representation comprising
a visual representation of the second time period,
a visual representation of the second plurality of sub-periods, wherein the visual representation of each sub-period of the second plurality of sub-periods is visually associated with a visual representation of tags that are associated with the each sub-period of the second plurality of sub-periods, and
a visual representation of the selectable time period, wherein the selectable time period includes the second time period.
